(19) United States
(12) Patent Application Publication
(10) Pub. No.: US 2008/0215799 A1
(43) Pub. Date: Sep. 4, 2008

(54) Control Chip of Adapter Interconnecting Pc and Flash Memory Medium and Method of Enabling the Control Chip to Program the Flash Memory Medium to be Accessible by the Pc

(76) Inventor: Hua-long Zhang, Guangdong (CN)

Correspondence Address: SAM CHEN, 7F-1, 293, ROOSEVELT ROAD, SEC 3, TAIPEI, TW

(21) Appl. No.: 11/813,999

(22) PCT Filed: Mar. 31, 2006
(86) PCT No.: PCT/CN2006/000570

§ 371 Date: Dec. 6, 2007

(30) Foreign Application Priority Data
Oct. 28, 2005 (CN) 200510100900.4

(51) Int. Cl. G06F 12/02

(52) U.S. Cl. 711/103; 711/E12.008

(57) ABSTRACT

In one embodiment an apparatus interconnecting a PC and a flash memory device is provided and includes a control chip including a RAM, a ROM, and a processor. The control chip is adapted to program the flash memory device as a main firmware stored with compatible configuration codes, an auxiliary firmware stored with programs of data encryption, flash memory device activation, and data compression, and a data storage segment so as to enable the PC to access the flash memory device via the control chip. Also, method of enabling the control chip to program the flash memory medium to be accessible by the PC is provided.

### BACKGROUND OF THE INVENTION

1. Field of Invention

The invention relates to flash memory access and more particularly to a control chip of adapter interconnecting PC and flash memory medium and method of enabling the control chip to program the flash memory medium to be accessible by the PC.

2. Description of Related Art

A wide variety of flash memory based data storage devices are available in recent years due to the fast progress of information technology. However, not all such data storage devices can be read by a PC (personal computer) because firmware of one flash memory medium may be different from that of another flash memory medium. Thus, it is desirable to provide apparatus and method for enabling a PC to access any type of flash memory mediums.

### SUMMARY OF THE INVENTION

It is therefore one object of the invention to provide an apparatus interconnecting a PC and a flash memory device, comprising a control chip including a RAM (random access memory); a ROM (read only memory); and a processor, wherein the control chip is adapted to program the flash memory device as a main firmware stored with compatible configuration codes, an auxiliary firmware stored with programs of data encryption, flash memory device activation, and data compression, and a data storage segment so as to enable the PC to access the flash memory device via the control chip.

It is another object of the invention to, in an apparatus including a control chip including a RAM (random access memory), a ROM (read only memory), and a processor, provide a method comprising the steps of interconnecting a PC and a flash memory device by means of the apparatus; causing the PC to detect the connection of the flash memory device; causing the PC to enable the processor to read programs from the ROM; causing the processor to execute the programs to read an ID (identification) segment of the flash memory device for obtaining data about type and capacity of the flash memory device; sending the type and the capacity of the flash memory device back to the PC; causing the PC to command the processor to program the flash memory device as one including a first memory segment, a second memory segment, and a data storage segment; causing the PC to send compatible configuration codes representing the type and the capacity of the flash memory device through the control chip to write into the first memory segment in a fixed form to form a main firmware, and send other programs including data encryption, flash memory device activation, and data compression through the control chip to write into the second memory segment in a fixed form to form an auxiliary firmware; causing the PC to command the control chip to format the data storage segment; causing the PC to command the processor to read programs from the main firmware and the auxiliary firmware and store a copy in the RAM; and causing the processor to execute the programs from the RAM for enabling the PC to access the flash memory device.

The above and other objects, features and advantages of the invention will become apparent from the following detailed description taken with the accompanying drawings.

### BRIEF DESCRIPTION OF THE DRAWINGS

FIG. 1 is a block diagram of a first preferred embodiment of an adapter interconnecting a PC and a flash memory medium according to the invention;

FIG. 2 is a block diagram of a second preferred embodiment of an adapter interconnecting a PC and a flash memory medium according to the invention;

FIG. 3 is a block diagram of a third preferred embodiment of an adapter interconnecting a PC and a flash memory medium according to the invention; and

FIG. 4 is a flow chart of programming a flash memory medium by a control chip of an adapter interconnecting a PC and the flash memory medium according to the invention.

### DETAILED DESCRIPTION OF THE INVENTION

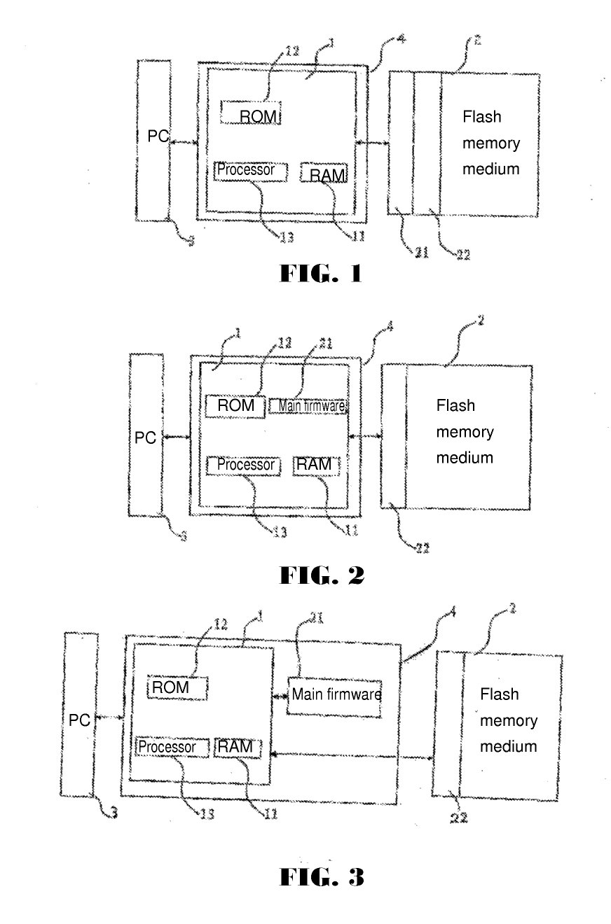

Referring to FIGS. 1 to 4, a memory programming method according to the invention is illustrated. As shown in FIG. 4, first, interconnect a PC 3 and a flash memory medium 2 by means of an adapter 4 (step A). The adapter 4 comprises a control chip 1 including a RAM (random access memory) 11, a ROM (read only memory) 12, and a processor 13. Preferably, the RAM 11 is a static random access memory (SRAM). Next, the PC 3 enables the processor 13 to read programs stored in the ROM 12 after detecting the connection of the flash memory medium 2 via the adapter 4 (step b1 of B). The processor 13 then executes the programs to read an ID (identification) segment of the flash memory medium 2 for obtaining data about type and capacity of the flash memory medium 2 (step b2 of B). The detection continues until it successes. The detection result containing the type and the capacity of the flash memory medium 2 is sent back to the PC 3 via the control chip 1 (step b3 of B). Next, the PC 3 commands the processor 13 to program the flash memory medium 2 as one including a first memory segment 21, a second memory segment 22, and a data storage segment. Next, the PC 3 sends compatible configuration codes representing the type and the capacity of the flash memory medium 2 through the control chip 1 to write into the first memory segment 21 in a fixed form to form a main firmware 21, and the PC 3 sends other programs including data encryption, flash memory medium activation, and data compression through the control chip 1 to write into the second memory segment 22 also in a fixed form to form an auxiliary firmware 22 (step c1 of C). Also, the PC 3 commands the control chip 1 to format the data storage segment of the flash memory medium 2 (step c2 of C). Thus, the PC 3 can command the processor 13 to read programs stored in the main firmware 21 and the auxiliary firmware 22 and store a copy in the RAM 11 and thereafter, the processor 13 executes the programs stored in the RAM 11 for enabling the PC 3 to access the flash memory medium 2 (step c3 of C). This finishes the programming of the flash memory medium 2.

Preferably, the main firmware 21 is implemented by a PROM (programmable read only memory), an EPROM (erasable programmable read only memory), or an EEPROM (electrically erasable programmable read only memory).

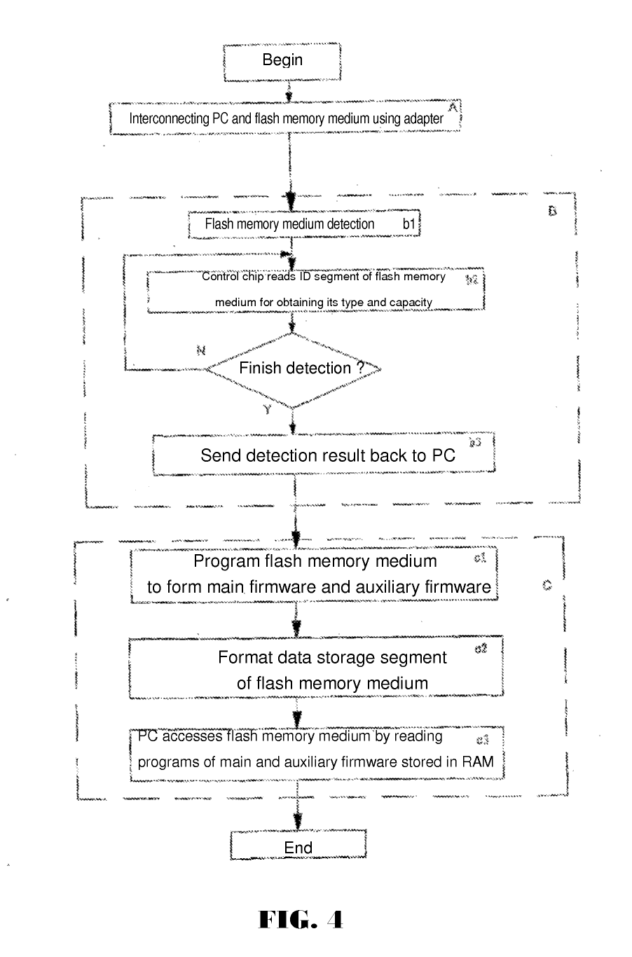

The main firmware 21 can be located in the flash memory medium 2 as shown in a first preferred embodiment of FIG. 1, in the control chip 1 as shown in a second preferred embodiment of FIG. 2, or in the adapter 4 but being external of the control chip 1 as shown in a third preferred embodiment of FIG. 3.

For example, in the market there is a type A flash memory medium produced by one manufacturer and there is a type B flash memory medium produced by a different manufacturer respectively. A user may interconnect a PC and either type of flash memory medium by means of the adapter of the invention. Thereafter, the adapter does the programming as described above. Finally, the PC can access the flash memory medium.

While the invention herein disclosed has been described by means of specific embodiments, numerous modifications and variations could be made thereto by those skilled in the art without departing from the scope and spirit of the invention set forth in the claims.

What is claimed is:

1. An apparatus interconnecting a PC (personal computer) and a flash memory device, comprising:
a control chip including a RAM (random access memory);
a ROM (read only memory); and
a processor,
wherein the control chip is adapted to program the flash memory device as a main firmware stored with compatible configuration codes, an auxiliary firmware stored with programs of data encryption, flash memory device activation, and data compression, and a data storage segment so as to enable the PC to access the flash memory device via the control chip.

2. The apparatus of claim 1, wherein the main firmware is located in the flash memory device.

3. The apparatus of claim 1, wherein the main firmware is located in the control chip.

4. The apparatus of claim 1, wherein the main firmware is located in the apparatus but externally of the control chip.

5. The apparatus of claim 1, wherein the main firmware is a PROM (programmable read only memory), an EPROM (erasable programmable read only memory), or an EEPROM (electrically erasable programmable read only memory).

6. The apparatus of claim 1, wherein the RAM is a static random access memory (SRAM).

7. In an apparatus including a control chip including a RAM (random access memory), a ROM (read only memory), and a processor, a method comprising the steps of:
interconnecting a PC (personal computer) and a flash memory device by means of the apparatus;
causing the PC to detect the connection of the flash memory device;
causing the PC to enable the processor to read programs from the ROM;
causing the processor to execute the programs to read an ID (identification) segment of the flash memory device for obtaining data about type and capacity of the flash memory device;
sending the type and the capacity of the flash memory device back to the PC;
causing the PC to command the processor to program the flash memory device as one including a first memory segment, a second memory segment, and a data storage segment;
causing the PC to send compatible configuration codes representing the type and the capacity of the flash memory device through the control chip to write into the first memory segment in a fixed form to form a main firmware, and send other programs including data encryption, flash memory device activation, and data compression through the control chip to write into the second memory segment in a fixed form to form an auxiliary firmware;
causing the PC to command the control chip to format the data storage segment;
causing the PC to command the processor to read programs from the main firmware and the auxiliary firmware and store a copy in the RAM; and
causing the processor to execute the programs from the RAM for enabling the PC to access the flash memory device.

8. The method of claim 7, wherein the main firmware is located in the flash memory device.

9. The method of claim 7, wherein the main firmware is located in the control chip.

10. The method of claim 7, wherein the main firmware is located in the apparatus but externally of the control chip.

11. The method of claim 7, wherein the main firmware is a PROM (programmable read only memory), an EPROM (erasable programmable read only memory), or an EEPROM (electrically erasable programmable read only memory).

12. The method of claim 7, wherein the RAM is a static random access memory (SRAM).
